(19) United States
(12) Patent Application Publication
(10) Pub. No.: US 2026/0157899 A1
(43) Pub. Date: Jun. 11, 2026

(54) BED FRAME

(71) Applicant: Sven KNABE, Gummersbach (DE)

(72) Inventor: Sven KNABE, Gummersbach (DE)

(21) Appl. No.: 19/317,785

(22) Filed: Sep. 3, 2025

(30) Foreign Application Priority Data
Sep. 19, 2024 (DE) 102024126944.8

(51) Int. Cl. A61G 7/015; A47C 19/02; A47C 20/04; A47C 31/10

(52) U.S. Cl. CPC A61G 7/015; A47C 19/025; A47C 20/04; A47C 31/10

(57) ABSTRACT

A bed frame has a rigid peripheral part formed by first and second relatively pivotal, generally planar, and rigid sections joined together at a first axis and pivotal between a generally coplanar position lying in a single plane and a not coplanar folded position. This peripheral part also has an outer face extending transversely of the plane. A respective stiff support part is secured within each section. The cover has a tensioning strip on the outer face of the peripheral part and a flexible web panel overlying and lying on the sections of the peripheral part, in the coplanar position of the sections with edges of the panel overlying the strip on the outer face of the peripheral part and extending under the peripheral. The panel further has at the first axis one or more elastic parts or regions, means releasably fixing the panel edges to the tensioning strip.

### FIELD OF THE INVENTION

The present invention relates to a bed frame. More particularly this invention concerns such a frame that is part of a hospital-type bed suitable for sitting or sleeping and that has a cover.

### BACKGROUND OF THE INVENTION

A bed frame has at least one first peripheral part with a dimensionally stable support part attached or attachable to the peripheral part. A cover therefore the peripheral part together with the support part in the desired position, and a circumferential tensioning strip fastened to the peripheral part or formed by the peripheral part extends transversely to a support plane of the support part and is covered and enclosed by edges of the cover. The cover's edges are folded over with their free end regions projecting beyond the tensioning strip and are fastened to parts of the tensioning strip on the underside, and the peripheral part together with the support part and the tensioning strip are formed by at least two frame sections and are folded over the ends projecting beyond the tensioning strip fixed to parts of the tensioning strip on the underside. The peripheral part together with the support part and the tensioning strip consist of at least a first and a second frame section that can be pivoted about a first pivot axis relative each other.

Such bed frames are known in the prior art, for example as frames for box spring beds or convertible couches. These have a peripheral part to which is attached a support part forming a support surface, for example for supporting a mattress. In an initial position of the bed frame in which movable parts, in particular support or peripheral parts, of the bed frame are provided in their initial position, the support surface is parallel to the installation plane of the bed frame. The bed frame has a surrounding tensioning strip extending with a certain width in the direction of the bed frame's installation plane and is covered by parts of the cover in order to make the bed frame visually appealing. When in the flat sleep position, the cover covers the peripheral part, the support part, and the tensioning strip, with the edges of the cover extending beyond the support part at the sides and covering the tensioning strip on the outside in its visible area. The ends of the edges are folded over around an edge of the tensioning strip facing the bed frame and fastened to parts of the tensioning strip on the underside. Underside means that the ends are fastened below the bed frame and are therefore not visible. The tensioning strip is usually made of wood to enable the cover to be attached to the tensioning strip in a cost-effective manner, e.g. using staples.

To enable the bed frame to be adjusted, the peripheral part, including the support part and tensioning strip, is divided into at least first and second frame sections pivotal relative to each other.

A disadvantage of such bed frames is that the covers fastened with staples cannot be removed from the tensioning strip without damage after they have been fixed in place. Cleaning or replacing the cover is therefore difficult or impossible.

Due to the stretching and compression of the material of the cover in the pivoting areas between the frame sections during pivoting, areas of the cover covering these pivoting areas are damaged. Also, if the cover is rigidly fastened with staples, the staples may be torn out or the cover may be torn.

### OBJECTS OF THE INVENTION

It is therefore an object of the present invention to provide an improved cover for a bed frame.

Another object is the provision of such an improved cover for a bed frame that overcomes the above-given disadvantages, in particular that where the cover can be easily attached to and replaced on the bed frame.

In addition, the formation of folds in the cover during adjustment of relatively movable frame sections should be reduced or avoided and tearing of the fabric should be prevented.

### SUMMARY OF THE INVENTION

These objects are attained according to the invention in a combination of a bed frame and a cover. The bed frame has according to the invention a rigid peripheral part formed by first and second relatively pivotal, generally planar, and rigid sections joined together at a first axis and capable of pivoting between a generally coplanar position lying in a single plane and a not coplanar folded position. This peripheral part also has an outer face extending transversely of the plane. A respective stiff support part is secured within each section. The cover has according to the invention a tensioning strip on the outer face of the peripheral part and a flexible web panel overlying and lying on the sections of the peripheral part, in the generally coplanar position of the sections with edges of the panel overlying the strip on the outer face of the peripheral part and extending under the peripheral. The panel further has in a region of the first axis one or more elastic parts or regions, means releasably fixing the panel edges to the tensioning strip.

Thus, the invention proposes that the cover has an elastic area and/or an elastic element at least in a first pivot axis between the first frame section and the second frame section, and that the ends are detachably clamped or inserted into the tensioning strip or parts of the tensioning strip in their intended position.

The first peripheral part, including the support part and tensioning strip, is divided into at least two frame sections so that the bed frame comprises, for example, a movable part for raising the upper body of a person lying in bed. Each frame section has a section of the first peripheral part, as well as the support part and the tensioning strip. The cover, on the other hand, is made in one piece and stretches over the frame sections as a whole. Made in one piece means that the cover is assembled into one piece, for example sewn or made from a single piece of material before being attached to the bed frame and is pulled over the frame sections as a whole and stretched around the tensioning strip. In order to be able to easily attach the cover to the bed frame and remove it from the bed frame without damage, it is detachably clamped or inserted onto or into the tensioning strip or its parts.

In the initial or sleep position, the frame sections lie next to each other in a common plane. This plane is parallel to the installation plane of the bed frame. The first section is moved by manually or motorized adjustment and pivoted relative to a second frame section about a first pivot axis into a comfortable position. In doing so, an area of the cover that covers the pivot axis between the frame sections is increasingly stretched or compressed depending on the degree of adjustment and the direction of adjustment. In order to enable this movement in the cover to be as wrinkle-free as possible, the cover is designed to be elastic in the pivot areas and/or has elastic elements such as rubber bands.

Preferably the peripheral part, including the support part and the tensioning strip, consists of at least three frame sections, and the third frame section can be pivoted about a second pivot axis relative to the second frame section. In this case the cover has an elastic area or an elastic element in a second pivot area between the second frame section and the third frame section, and it is particularly preferred that a fourth frame section is held on the first frame section, which can be pivoted around a third pivot axis relative to the first frame section, and/or a fifth frame section is held on the third frame section that can be pivoted around a fourth pivot axis relative to the third frame section. The cover has an elastic region or an elastic element in a third pivot region between the first frame section and the fourth frame section and/or in a fourth pivoting region between the third frame section and the fifth frame section.

In all designs, the frame sections are provided in a starting position in a common plane in a row next to each other. A respective pivoting axis is provided between every two adjacent frame sections, where the covering is stretched or compressed when the sections are adjusted, i.e., pivoted. Elastic areas and/or elements are preferably provided in the cover in each of these pivot areas. In a three-part design, a fixed middle section and a pivoting head section and foot section are preferably provided. In a five-part design, it is preferable for the foot section and head section to be further subdivided. This allows for particularly versatile and convenient adjustment.

It is also preferred that the elastic areas or elements are provided in the edges or in the ends of the cover. This reduces the formation of folds, particularly in the visible area of the bed frame.

It is also preferable that the frame sections are pivotal relative to each other or to parts of the bed frame and the pivot axis and/or the pivot axes are preferably directed transversely to a longitudinal extension of the bed frame and parallel to an installation plane of the bed frame.

It is also preferable that a plurality of clips are fastened to the edges of the cover and the tensioning strip has clamping profiles onto which or into which the clips are fitted or inserted in the desired position.

The cover can be easily attached to the bed frame using the clips and can also be removed from the bed frame in order to wash the cover or attach a different cover to the frame.

It is preferably provided that the clips are plastic profiles, preferably L-profiles, U-profiles, or C-profiles. Such profiles can be manufactured easily and inexpensively and attached to the cover.

It is also preferable for the clips to be sewn to the ends of the cover so that the clips are held securely to the cover.

The cover is preferably made of fabric or leather or plastic or a combination of these materials. Also the cover is preferably quilted or glued or laminated with foam or mesh.

The cover has a rectangular or square shape and, in its intended position, is provided on the bed frame so as to cover at least the support part with the edges in their intended position projecting vertically from the cover part and being directed toward the support surface and covering the tensioning strip.

This cover can be made from a single piece of material. Alternatively, it may be preferable for the cover part to be sewn to the edges.

The cover part can then be made of a material which is, for example, less expensive than the material of the edges, since only the edges are visible.

It is preferable that the elastic area is an elastic section of the cover.

Alternatively, it is preferable that the elastic element is a band or a strip, the element preferably consisting of an elastic band.

It is also particularly preferred that the clips and the elastic elements are provided in an alternating sequence at the edges of the cover, so that only the elastic elements are provided in the pivot areas between the frame sections.

### BRIEF DESCRIPTION OF THE DRAWING

The above and other objects, features, and advantages will become more readily apparent from the following description, reference being made to the accompanying drawing in which:

FIG. 1 is an oblique view from below of a cover according to the invention on its frame in the normally planar sleep position thereof; and

FIG. 2 shows the bed frame with cover in a sitting position of the frame.

### SPECIFIC DESCRIPTION OF THE INVENTION

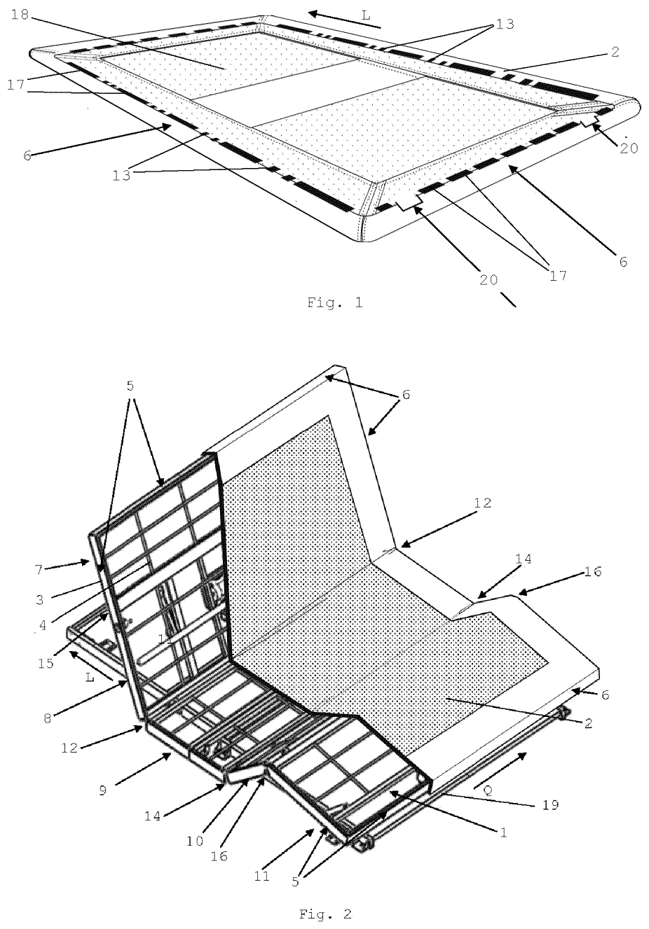

The drawing shows a cover 2 seen in FIG. 1 for a bed frame 1 seen in FIG. 2. This bed frame 1 has a first peripheral part 3 formed mainly by angle irons and a dimensionally stable support part 4 formed by a grid of metal bars attached to it when installed in its intended position, the cover 2 extends over the peripheral part 3 and the support part 4 and a surrounding tensioning strip 5 is attached to the peripheral part 3 as shown in FIG. 2. The tensioning strip 5 extends transversely to a support plane of the support part 4 and is covered and enclosed by edges 6 of the cover 2. The edges 6 are folded over with their free ends projecting beyond the tensioning strip 5 and are fixed to the tensioning strip 5 on part 3's underside. The first peripheral part 3, together with the support part 4 and tensioning strip 5, is formed by five rigid frame sections 7, 8, 9, 10, 11. All the frame sections 7, 8, 9, 10, 11 and tensioning strip 5 lie in a common plane in an initial position and lie in a row next to each other as shown in FIG. 1. The common plane is parallel to the installation plane of the bed frame and this position is used for sleeping. The frame sections 7, 8, 10, 11 can be pivoted relative to each into the position of FIG. 2 where only sections 7 and 8 remain coplanar. Thus FIG. 2 shows a position where the user would be sitting up with legs elevated, although other positions are of course possible.

More precisely, the bed frame 1 shown in FIG. 2 has first back section 7 and 8 that are relatively pivotal about an axis 15 and pivotal together on a second seat section 9 about a first pivot axis 12 relative to the second seat section 9. The edges of the cover 2 stretch across the first pivot axis 12 between the first frame section 8 and the second frame section 9. To prevent creasing and/or damage to the cover material in this area, elastic elements 13 are sewn into the edge 6.

The second frame section 9 is attached to a second peripheral part 19 of the bed frame 1, for example welded to this second peripheral part 19.

A third thigh section 10 is also pivotal on the second frame section 10 and about a second pivot axis 14. The edge 6 has further elastic elements 13 in the area spanning the second pivot axis 14 between the second frame section 9 and the third frame section 10 in order to prevent the cover 2 from creasing or being damaged in the region of this pivot axis 14 as well.

Further such elastic elements 13 are provided in the edge 6 in a region covering the third pivoting region between the first frame section 8 and a fourth neck section 7 (neck part) and in a region covering the axis 16 between a fourth pivoting region between the third frame section 10 and a fifth foot section 11.

The pivot axes 12, 14, 15, and 16 parallel to one another extend in a transverse direction Q to a longitudinal direction L of the bed frame parallel to a plane of the bed frame 1 in the FIG. 1 position.

The cover is made in one piece and is stretched over the frame sections 7, 8, 9, 10, and 11. “One piece” means that the cover 2 is assembled into one piece before being attached to the bed frame 1, e.g. by sewing several parts together, or is made from one piece and is pulled over the frame sections 7, 8, 9, 10, 11 as a whole and stretched around the tensioning strip 5. This shortens the assembly time and greatly simplifies assembly in general.

The cover 2 is fastened with plastic clips 17 that are preferably sewn onto the ends of the edges 6, whereby the clips 17 are clamped or inserted into a clamping profile of the tensioning strip 5 in the desired position. The clips 17 can be released at any time so that the cover 2 can be easily removed from the bed frame 1 without damage.

The elastic areas or elements 13 are incorporated into the edges 6 or into the ends so that the formation of folds is reduced, particularly in the visible area of the bed frame 1. In addition, further elastic areas or elements 13 may also be provided in areas of the cover 2 that cover the support part 4.

No clips 17 are provided in the edge area where the cover 2 is elastically deformed or where the cover 2 has elastic elements 13, so that this area is not fixed to parts of the bed frame 1 but is freely movable when the frame sections 7, 8, 10, 11 are relatively pivoted. The elastic areas or elements 13 can thus expand or contract with the pivot movement of the frame sections 7, 8, 10, 11.

FIG. 1 shows an example of the design of a cover 2 according to the invention in a diagonal view from below. It has a rectangular or square main or center panel 18 from which the edges 6 project. A plurality of clips 17 are attached to the edges 6, clips 17 and rubber bands being alternately attached as elastic elements 13 to the ends extending in the longitudinal direction L such that, when the cover is pulled over a bed frame 1 and attached thereto, they are in the pivoting areas.

The invention is not limited to the embodiments described, but is variable within the scope of the disclosure. All new individual and combined features disclosed in the description and/or drawings are considered essential to the invention.

1. In combination:
a bed frame comprising:
a rigid peripheral part formed by first and second relatively pivotal, generally planar, and rigid sections joined together at a first axis and capable of pivoting between a generally coplanar position lying in a single plane and a not coplanar folded position, the peripheral part having an outer face extending transversely of the plane, and
a respective stiff support part secured within each section, and
a cover comprising:
a tensioning strip on the outer face of the peripheral part,
a flexible web panel overlying and lying on the sections of the peripheral part, in the generally coplanar position of the sections with edges of the panel overlying the strip on the outer face of the peripheral part and extending under the peripheral, the panel further having in a region of the first axis one or more elastic parts or regions;
means releasably fixing the panel edges to the tensioning strip.

2. The combination according to claim 1, wherein the peripheral part is formed by the first and second sections and also by a third section pivoted at a second axis on the second section, the cover having an elastic region or an elastic element at the second pivot axis between the second frame section and the third frame section.

3. The combination according to claim 2, wherein the peripheral part is formed by the first, second, and third sections and also by a fourth section pivoted at a third axis on the third section, the cover having an elastic region or an elastic element at the third pivot axis between the second frame section and the third frame section.

4. The combination according to claim 1, wherein the elastic elements are provided in the edges or in ends of the cover.

5. The combination according to claim 2, wherein the pivot axes are substantially parallel to each other and extend transversely of a length direction of the frame.

6. The combination according to claim 1, wherein the means is a plurality of clips fastened to the edges of the cover, the tensioning strip having clamping profiles onto which or into which the clips are placed or inserted in a desired position.

7. The combination according to claim 6, wherein the clips are plastic L-profiles, U-profiles, or C-profiles.

8. The combination according to claim 6, wherein the clips are sewn to the ends of the cover.

9. The combination according to claim 1, wherein the panel is made of fabric, leather, plastic or a combination of these materials.

10. The combination according to claim 1, wherein the cover is quilted, glued or laminated with foam or mesh.

11. The combination according to claim 1, wherein the cover is rectangular or square cover and in its intended position is provided on the bed frame so as to cover at least the support part, the edges projecting perpendicularly from the cover part and being directed toward the support surface so as to cover the tensioning strip.

12. The combination according to claim 11, the cover panel is sewn to the edges.

13. The combination according to claim 1, wherein the elastic part is an elastic material section of the cover.

14. The combination according to claim 1, wherein the elastic element is a band or a strip, wherein the element is preferably made of an elastic band.

15. The combination according to claim 1, wherein the clips and the elastic elements alternate at the edges of the cover.
